(19) United States
(12) Patent Application Publication
(10) Pub. No.: US 2017/0342925 A1
(43) Pub. Date: Nov. 30, 2017

(54) CONTROL DEVICE FOR INTERNAL COMBUSTION ENGINES

(71) Applicant: NISSAN MOTOR CO., LTD., Kanagawa (JP)

(72) Inventors: Futoshi Yoshimura, Kanagawa (JP); Ryo Uchida, Kanagawa (JP); Tomoyoshi Date, Kanagawa (JP); Rina Kamio, Kanagawa (JP)

(73) Assignee: NISSAN MOTOR CO., LTD., Kanagawa (JP)

(21) Appl. No.: 15/532,614

(22) PCT Filed: Dec. 2, 2014
(86) PCT No.: PCT/JP2014/081814

§ 371 Date: Jun. 2, 2017

(51) Int. Cl. F02D 41/12; F02D 41/40; F02D 41/38

(52) U.S. Cl. CPC F02D 41/126; F02D 41/40; F02D 2041/389

(57) ABSTRACT

A control device for an internal combustion engine of a vehicle has a controller that controls a fuel injection valve of the internal combustion engine arranged to directly inject a fuel into a combustion chamber, and a pressure regulator of the internal combustion engine arranged to vary a pressure of the fuel supplied to the fuel injection valve. The controller performs a fuel cut that stops the fuel injection of the fuel injection valve when a predetermined fuel cut condition is satisfied during a traveling of the vehicle. The controller restarts the fuel injection of the fuel injection valve when a predetermined fuel cut recovery condition is satisfied during the fuel cut.

### BACKGROUND

### Technical Field

This invention relates to a control device for an internal combustion engine in which a fuel is injected directly into a combustion chamber.

### Related Art

Conventionally, there is known an internal combustion engine of an in-cylinder direct injection type in which a plurality of divided (split) injection of a fuel into a combustion chamber is performed during one combustion cycle. With this, a fuel injection amount per one time is decreased so as to decrease fuel adhesion to a wall surface and so on.

For example, in Patent Document 1, when the fuel injection is restarted from a fuel cut state where the fuel injection into the combustion chamber is temporarily stopped, the injection amount ratio at a first time in the divide injection is decreased as a fuel cut time period during which the fuel injection into the combustion chamber is stopped is longer. With this, the discharge number of the exhaust particulate is suppressed.

However, in Patent Document 1, when the fuel injection is restarted from the fuel cut state, the engine load is low. When the fuel injection amount at the one combustion cycle becomes less, the number of the fuel injection during the one combustion cycle may not be divided into plural number, and the injection amount ratio at the first time in the split injection may not be decreased. Accordingly, in Patent Document 1, when the fuel injection is restarted from the fuel cut state, the discharge amount of the exhaust particulate and the discharge number of the exhaust particulate may be increased.

Patent Document 1: Japanese Patent Application No. 2012-241654

### SUMMARY

In one or more embodiments of the present invention, a control device for an internal combustion engine of a vehicle comprises a controller that controls a fuel injection valve of the internal combustion engine arranged to directly inject a fuel into a combustion chamber, and a pressure regulator of the internal combustion engine arranged to vary a pressure of the fuel supplied to the fuel injection valve. The controller performs a fuel cut that stops the fuel injection of the fuel injection valve when a predetermined fuel cut condition is satisfied during a traveling of the vehicle. The controller restarts the fuel injection of the fuel injection valve when a predetermined fuel cut recovery condition is satisfied during the fuel cut. The pressure of the fuel supplied to the fuel injection valve is set to a value higher than a normal state fuel pressure determined in accordance with a driving state, at the restart of the fuel injection after the fuel cut. The pressure of the fuel supplied to the fuel injection valve is increased at the restart of the fuel injection from the fuel cut as a time period of the fuel cut becomes longer.

With this, it may be possible to promote atomization and vaporization of spray at the restart of the fuel injection after the end of the fuel cut, to decrease the fuel adhesion amount to the piston and so on, and to suppress the discharge amount of the exhaust particulate and the discharge number of the exhaust particulate.

### BRIEF DESCRIPTION OF DRAWINGS

FIG. 1 is an explanatory view schematically showing a schematic configuration of an internal combustion engine according to one or more embodiments of the present invention.

FIG. 2 is a normal state fuel pressure calculation map.

FIG. 3 is a timing chart at a deceleration of a vehicle with a fuel cut in a first embodiment of the present invention.

FIG. 4 is a flow chart showing a flow of a control in the first embodiment.

FIG. 5 is a target fuel pressure calculation map during a fuel cut.

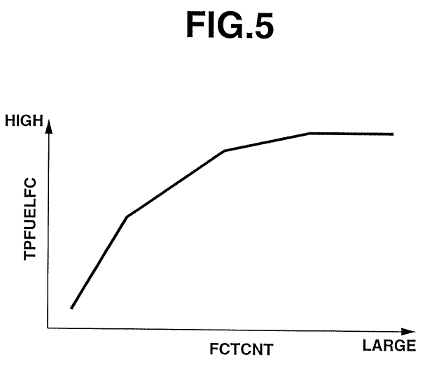

FIG. 6 a timing chart at the deceleration of the vehicle with the fuel cut in a second embodiment of the present invention.

FIG. 7 is a flow chart showing a flow of a control in the second embodiment.

FIG. 8 is a target fuel pressure calculation map.

FIG. 9 is a timing chart at a deceleration of a vehicle with a fuel cut in a third embodiment of the present invention.

FIG. 10 is a normal state injection timing map.

FIG. 11 is a flow chart showing a flow of a control in the third embodiment.

### DETAILED DESCRIPTION

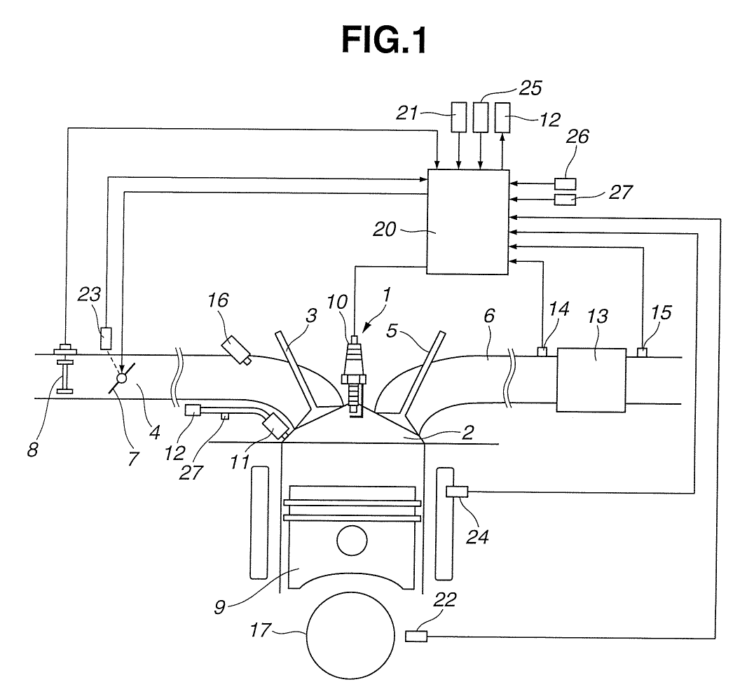

Hereinafter, embodiments of the present invention are illustrated in details with reference to the drawings. In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention. FIG. 1 shows a schematic configuration of an internal combustion engine 1 according to one or more embodiments of the present invention. Besides, the internal combustion engine 1 uses a gasoline as a fuel.

A combustion chamber 2 of the internal combustion engine 1 is connected through an intake valve 3 to an intake passage 4. Moreover, the combustion chamber 2 is connected through an exhaust valve 5 to an exhaust passage 6.

An electrically controlled throttle valve 7 is disposed on the intake passage 7. An air flow meter 8 is provided on an upstream side of the throttle valve 7. The air flow meter 8 is arranged to sense an intake air amount. A detection signal of the air flow member 8 is inputted into an ECU (engine control unit) 20.

An ignition plug 10 is disposed at a top portion of the combustion chamber 2 to confront a piston 9. A first fuel injection valve 11 is disposed on a side portion of this combustion chamber 2 on the intake passage's side. The first fuel injection valve 11 is arranged to directly inject the fuel into the combustion chamber 2.

The fuel pressurized by a high pressure fuel pump (not shown) to have a relatively high pressure is introduced into the first fuel injection valve 11 through a pressure regulator 12 serving as a pressure regulating device. The pressure regulator 12 is arranged to vary a pressure of the fuel (fuel pressure) supplied to the first fuel injection valve 11 based on a control command from the ECU 20. Besides, the pressure regulating device is not limited to the pressure regulator 12. The pressure regulating device may be a device arranged to vary the pressure of the fuel (the fuel pressure) supplied to the first fuel injection valve 11.

A three-way catalyst 13 is disposed on the exhaust passage 6. A first air-fuel ratio sensor 14 is disposed on the exhaust passage 6 on an upstream side of the three-way catalyst 13. A second air-fuel ratio sensor 15 is disposed on the exhaust passage 6 on a downstream side of the three-way catalyst 13. The air-fuel ratio sensors 14 and 15 may be oxygen sensors arranged to sense only a rich and lean of the air fuel ratio. Alternatively, the air-fuel ratio sensors 14 and 15 may be wide area type air-fuel ratio sensors by which an output according to the value of the air fuel ratio can be obtained.

The ECU 20 includes a microcomputer. The ECU 20 is configured to perform various controls of the internal combustion engine 1. The ECU 20 is configured to perform the operations based on signals from various sensors. The various sensors are the above-described air flow meter 8, the first and second air-fuel ratio sensors 14 and 15, an accelerator opening degree sensor 21 arranged to sense an opening degree (depression amount) of an accelerator pedal operated by the driver, a crank angle sensor 22 arranged to sense a crank angle of a crank shaft 17, and the engine speed, a throttle sensor 23 arranged to sense an opening degree of the throttle valve 7, a water temperature sensor 24 arranged to sense a coolant temperature of the internal combustion engine 1, an oil temperature sensor 25 arranged to sense an oil temperature of an engine oil, a vehicle speed sensor 26 arranged to sense a vehicle speed, a fuel pressure sensor 27 arranged to sense the fuel pressure supplied to the first fuel injection valve 11, and so on.

The ECU 20 is configured to control the injection amount and the injection timing of the first fuel injection valve 11, the pressure of the fuel (the fuel pressure) supplied to the first fuel injection valve 11, an ignition timing by the ignition plug 10, the opening degree of the throttle valve 7, and so on.

Besides, the internal combustion engine 1 includes a second fuel injection valve 16 disposed on the downstream side of the throttle valve 7, and arranged to inject the fuel into the intake passage 4 in each cylinder. That is, it is possible to supply the fuel into the combustion chamber 2 by the port injection.

The ECU 20 is configured to perform the fuel cut control to stop the fuel injections of the first fuel injection valve 11 and the second fuel injection valve 16. For example, when the engine speed is equal to or greater than a predetermined fuel cut rotation speed and the throttle valve 7 is fully closed, the fuel cut conditions are satisfied. Accordingly, the ECU 20 performs the fuel cut control. The ECU 20 is configured to restart the fuel injection of the first fuel injection valve 11 when predetermined fuel cut recovery conditions are satisfied during the fuel cut control. For example, when the throttle valve 7 is not in the fully closed state by the depression of the accelerator pedal, or when the engine speed becomes equal to or smaller than the predetermined fuel cut recovery rotation speed, the fuel cut recovery conditions are satisfied. Accordingly, the ECU 20 finishes the fuel cut control.

When the fuel cut control is performed, the relatively much oxygen are supplied to the three-way catalyst 13. That is, the three-way catalyst 13 adsorbs the much oxygen during the fuel cut control. The three-way catalyst 13 may be hard to reduce NOx by depriving of the oxygen from the NOx in the exhaust air at the end of the fuel cut control. Accordingly, in one or more embodiments of the present invention, when the fuel injection is restarted after the end of the fuel cut control, the rich spike by which the fuel injection amount injected from the first fuel injection valve 11 is temporarily increased is performed. With this, the recovery of the exhaust air purification capability (NOx reduction capability) of the three-way catalyst 13 is promoted.

In this case, the combustion of the internal combustion engine 1 is stopped during the fuel cut control. Accordingly, the wall surface temperature of the combustion chamber 2, that is, the temperature of the piston 9, the cylinder inner wall surface and so on is decreased. Therefore, when the fuel injection of the first fuel injection valve 11 is restarted after the end of the combustion cut control, the adhesion amount of the fuel injected from the first fuel injection valve 11 into the combustion chamber 2 to the piston 9 and so on is increased. The discharged amount and the discharged number of the exhaust particulate may be increased.

Accordingly, in the first embodiment of the present invention, when the fuel injection is restarted from the first injection valve 11 during the intake process, the pressure of the fuel (the fuel pressure) supplied to the first fuel injection valve 11 is increased to a value greater than the normal state fuel pressure determined in accordance with the engine load at that time.

For example, when the engine speed becomes equal to or smaller than the predetermined fuel cut recovery rotation speed to satisfy the fuel cut recovery condition, the pressure of the fuel (the fuel pressure) supplied to the first fuel injection valve 11 at the restart of the fuel injection is set to a value greater than the normal state fuel pressure at the idling drive state. Moreover, when the throttle valve 7 is not in the fully closed state by the depression of the accelerator pedal during the fuel cut control to satisfy the fuel cut recovery condition, the pressure of the fuel (the fuel pressure) supplied to the first fuel injection valve 11 at the restart of the injection is set to the value greater than the normal state fuel pressure in the driving state at the restart of the fuel injection.

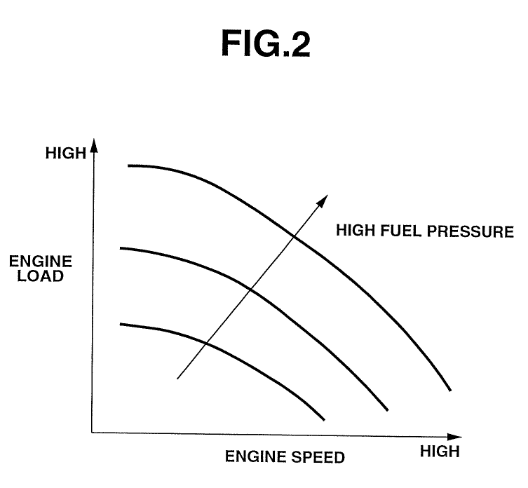

For example, the normal state fuel pressure is calculated by using the normal state fuel pressure calculation map, as shown in FIG. 2. In this normal state fuel pressure calculation map, the calculated normal state fuel pressure is set to the higher value as the engine load is higher, and as the engine speed is higher.

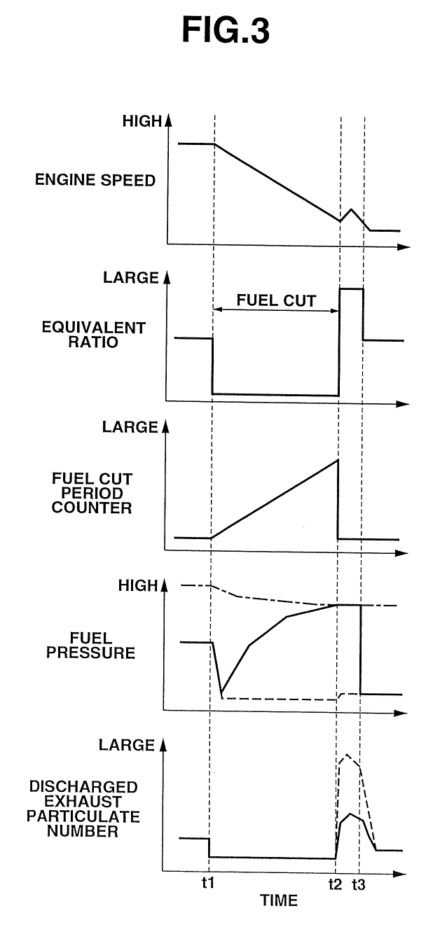

FIG. 3 is a timing chart showing a state at a transition from the fuel cut control after the end of the fuel cut in the first embodiment.

In FIG. 3, the fuel cut conditions are satisfied at time t1. At time t2 at which the engine speed becomes equal to or smaller than the predetermined fuel cut recovery rotation speed by without the depression of the accelerator pedal, the fuel cut recovery condition is satisfied. Moreover, the equivalent ratio is controlled to be temporarily increased during a predetermined period from time t2. That is, the rich spike by which the fuel injection amount injected from the first fuel injection valve 11 is temporarily increased is performed during the time period from time t2 to time t3.

In the first embodiment, the pressure of the fuel (the fuel pressure) supplied to the first fuel injection valve 11 at the end of the fuel cut control is set to the value greater than the normal state fuel pressure shown by a broken line in FIG. 3. Specifically, the pressure of the fuel (the fuel pressure) supplied to the first fuel injection valve 11 is set to the value greater than the normal state fuel pressure at the idling drive, during the time period from the time t2 to the time t3, during which the rich spike is performed.

In this way, when the fuel injection is restarted from the first fuel injection valve 11, the pressure of the fuel (the fuel pressure) supplied to the first fuel injection valve 11 is set to the value greater than the normal state fuel pressure. With this, the atomization and the vaporization of the spray of the fuel injected from the first fuel injection valve 11 are promoted. Accordingly, it is possible to decrease the fuel adhesion amount to the piston 9 and so on. Therefore, when the fuel injection is restarted from the first fuel injection valve 11 after the fuel cut control, it is possible to largely decrease the discharge number of the exhaust particulate, relative to a case where the fuel pressure is set to the normal state fuel pressure as shown by the broken line in FIG. 3. Moreover, it is possible to suppress the discharge amount of the exhaust particulate. That is, it is possible to suppress the deterioration of the exhaust capability immediately after the end of the fuel cut control, while decreasing the fuel economy by the fuel cut control.

Furthermore, the pressure of the fuel (the fuel pressure) supplied to the first fuel injection valve 11 is set to the higher value as the time period after which the fuel cut recovery conditions are satisfied from the time t1 becomes longer, that is, as the fuel cut period counter counted from the time t1 to the satisfaction of the fuel cut recovery conditions at constant interval becomes larger. This is because the wall surface temperature of the combustion chamber 2 is decreased as the immediately preceding fuel cut control becomes longer, with this, the adhesion amount of the fuel injected at the restart of the fuel injection of the first fuel injection valve 11 to the piston 9 and so on tends to be increased.

Accordingly, by setting the pressure of the fuel (the fuel pressure) supplied to the first fuel injection valve at the fuel injection restart to the higher value as the fuel cut period counter becomes greater, it is possible to effectively decrease the adhesion amount of the injected fuel to the piston 9 and so on.

Moreover, the pressure of the fuel (the fuel pressure) supplied to the first fuel injection valve 11 is controlled to previously increased during the fuel cut control. Accordingly, when the fuel injection is restarted from the first fuel injection valve 11, it is possible to inject the fuel having the high pressure from the first time. Accordingly, it is possible to promote the atomization and the vaporization of the spray, which may decrease the discharge number of the exhaust particulate.

The fuel pressure shown by one dot line in FIG. 3 is a permissible maximum fuel pressure determined from a minimum fuel injection pulse width of the first fuel injection 11. This permissible maximum fuel pressure is a maximum value of the pressure of the fuel (the fuel pressure) supplied to the first fuel injection valve 11 during the fuel cut control. For example, the permissible maximum fuel pressure is determined by the intake air amount during the fuel cut, and the minimum fuel injection pulse width of the first fuel injection valve 11. Besides, the permissible maximum fuel pressure may be determined by the intake air amount at the idling driving, and the minimum fuel injection pulse width of the first fuel injection valve 11.

By setting the permissible maximum fuel pressure in this way, it is possible to avoid the injection request in which the fuel injection pulse width of the first fuel injection valve 11 becomes equal to or smaller than the minimum fuel injection pulse width.

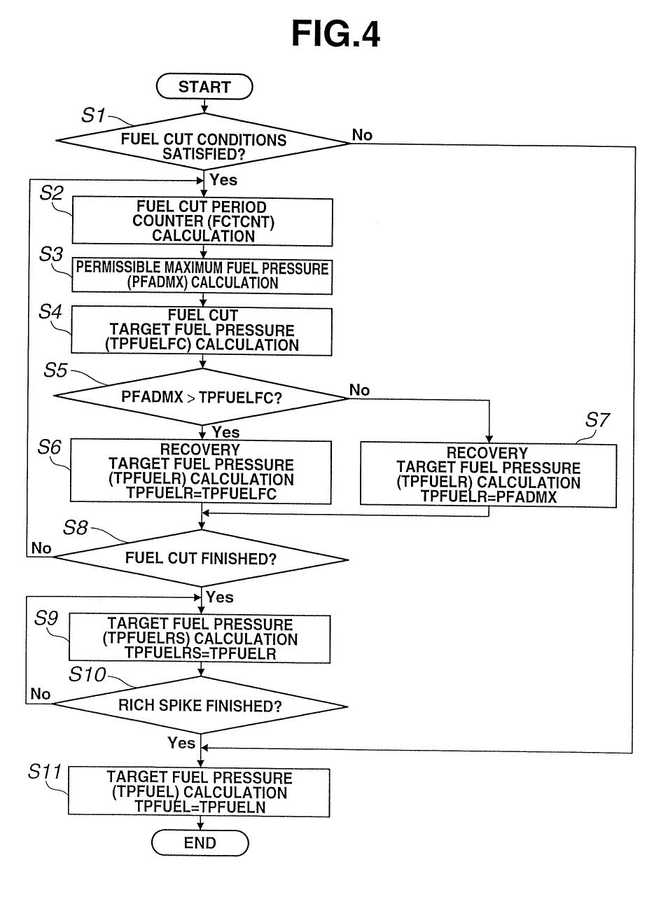

FIG. 4 is a flow chart showing a flow of the control in the above-described first embodiment. At S1, it is judged whether or not the fuel cut conditions are satisfied. When the fuel cut conditions are satisfied, the process proceeds to S2. When the fuel cut conditions are not satisfied, the process proceeds to S11. At S2, the fuel cut period counter (FCTCNT) is calculated. At S3, the permissible maximum fuel pressure (PFADMX) is calculated. At S4, a fuel cut target fuel pressure (TPFUELFC) which is a target value of the pressure of the fuel (the fuel pressure) supplied to the first fuel injection valve 11 during the fuel cut is calculated. This fuel cut target fuel pressure (TPFUELFC) is calculated, for example, by using a fuel cut target fuel pressure calculation map. The fuel cut target fuel pressure (TPFUELFC) becomes higher as a fuel cut period counter (FCRCNT) becomes greater. At S5, the permissible maximum fuel pressure (PFADMX) and the fuel cut target fuel pressure (TPFUELFC) are compared with each other. When the permissible maximum fuel pressure (PFADMX) is greater than the fuel cut target fuel pressure (TPFUELFC), the process proceeds to S6. Otherwise, the process proceeds to S7. At S6, a recovery target fuel pressure (TPFUELLR) which is the pressure of the fuel (the fuel pressure) supplied to the first fuel injection valve 11 at the fuel cut recovery is set to the fuel cut target fuel pressure (TPFUELFC) calculated at S4. At S7, the recovery target fuel pressure (TPFUELLR) which is the pressure of the fuel (the fuel pressure) supplied to the first fuel injection valve 11 at the fuel cut recovery is set to the permissible maximum fuel pressure (PFADMX).

At S8, it is judged whether or not the fuel cut is finished. That is, it is judged whether or not the fuel cut recovery conditions are satisfied. When the fuel cut recovery conditions are satisfied, the process proceeds to S9. When the fuel cut recovery conditions are not satisfied, the process proceeds to S2. At S9, the target fuel pressure (TPFUELRS) which is the target value of the pressure of the fuel (the fuel pressure) supplied to the first fuel injection valve 11 during the rich spike is set to the recovery target fuel pressure (TPFUELLR) calculated immediately before the satisfaction of the fuel cut recovery conditions. At S10, it is judged whether or not the rich spike is finished. When the rich spike is finished, the process proceeds to S11. When the rich spike is not finished, the process proceeds to S9. At S11, the target fuel pressure (TPFUELS) is set to the normal state fuel pressure (TPFUELN) calculated from the normal state fuel pressure calculation map of FIG. 2 by using the current engine load and the current engine speed.

Hereinafter, other embodiments of the present invention are explained. Constituting elements which are the same as the above-described first embodiment have the same symbols. The repetitive explanations are omitted.

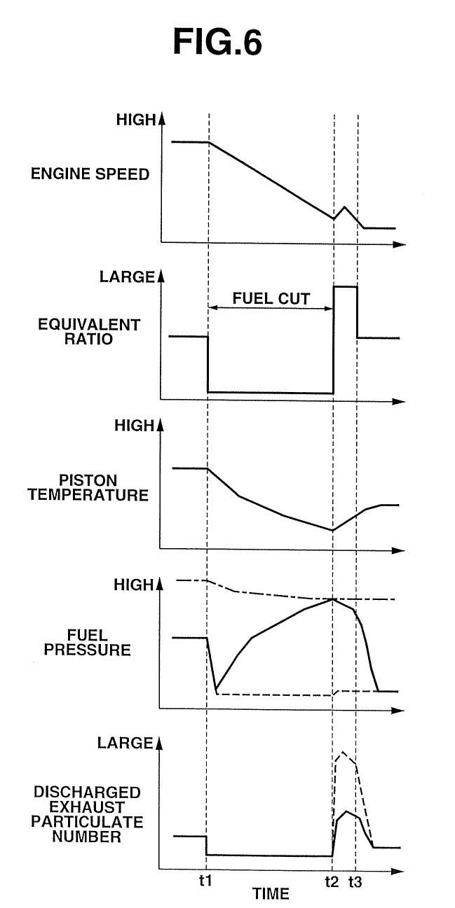

A second embodiment of the present invention is explained with reference to FIG. 6 to FIG. 8. The second embodiment has a configuration similar to that of the first embodiment. In the second embodiment, the pressure of the fuel (the fuel pressure) supplied to the first fuel injection valve 11 at the end of the fuel cut control is control to the value greater than the normal state fuel pressure shown by a broken line in FIG. 6, like the above-described first embodiment.

In this second embodiment, the pressure of the fuel (the fuel pressure) supplied to the first fuel injection valve 11 is set to be increased in accordance with the temperature of the piston 9. This is because the adhesion amount of the fuel injected at the fuel injection recovery of the first fuel injection valve 11 to the piston 9 and so on tends to be increased as the temperature of the piston 9 is lowered.

Accordingly, in this second embodiment, it is possible to effectively decrease the adhesion amount of the injected fuel to the piston 9 and so on at the recovery of the fuel injection of the first fuel injection valve 11.

For example, the temperature of the piston 9 can be calculated from a predetermined calculation formula by the engine load immediately before the fuel cut control, and the accumulated intake air amounts during the fuel cut control, and so on. Besides, the temperature of the piston 9 may be sensed by a temperature sensor.

In FIG. 6, the fuel cut conditions are satisfied at time t1. At time t2 at which the engine speed becomes equal to or smaller than the predetermined fuel cut recovery rotation speed without the depression of the accelerator pedal, the fuel cut recovery conditions are satisfied. Moreover, the equivalent ratio during the predetermined period from the time t2 is controlled to be increased. That is, the rich spike by which the fuel injection amount injected from the first fuel injection valve 11 is temporarily increased is performed from time t2 to time t3.

Moreover, in this second embodiment, when the fuel injection is restarted by the end of the fuel cut control, the pressure of the fuel (the fuel pressure) supplied to the first fuel injection valve 11 is set to be the higher value as the temperature of the piston 9 becomes lower.

Besides, the fuel pressure shown by one dot line in FIG. 6 is the above-described permissible maximum fuel pressure. The permissible maximum fuel pressure is determined from the minimum fuel injection pulse width of the first fuel injection 11. Furthermore, the pressure of the fuel (the fuel pressure) supplied to the first fuel injection valve 11 is previously controlled to be the high value during the fuel cut control.

Accordingly, in this second embodiment, when the fuel injection is restarted from the first fuel injection valve 11 after the fuel cut control is finished, it is possible to largely decrease the discharge number of the exhaust particulate, relative to a case where the fuel pressure is set to the normal state fuel pressure as shown in FIG. 6. With this, it is possible to suppress the discharge amount of the exhaust particulate. Moreover, in this second embodiment, it is possible to attain the operations and the effects that may be similar to those of the first embodiment.

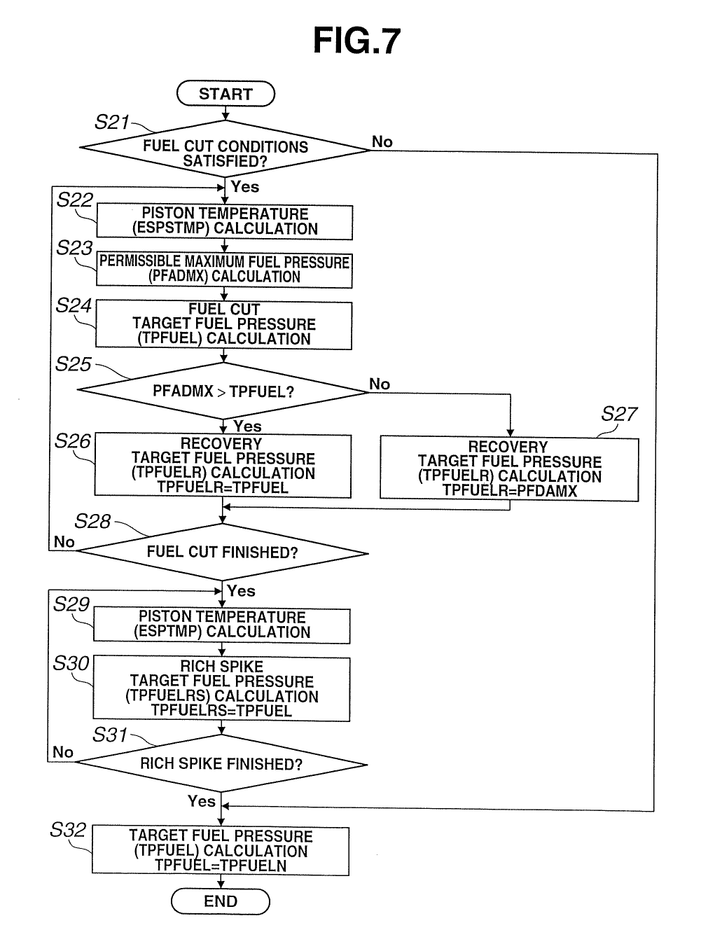

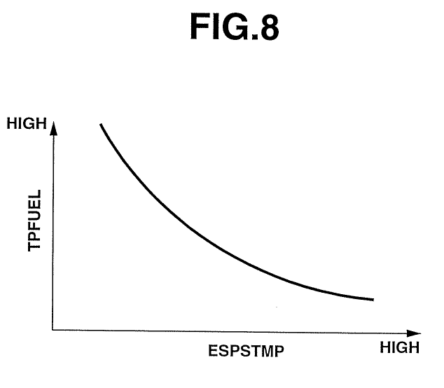

FIG. 7 is a flow chart showing a flow of the control in the above-described second embodiment. At S21, it is judged whether or not the fuel cut conditions are satisfied. When the fuel cut conditions are satisfied, the process proceeds to S22. When the fuel cut conditions are not satisfied, the process proceeds to S32. At S22, the piston temperature (ESPTEMP) is calculated from a predetermined calculation formula by using the engine load immediately before the fuel cut control, the accumulated intake air amount during the fuel cut control, and so on. At S23, the permissible maximum fuel pressure (PFADMX) is calculated. At S24, the target fuel pressure (TPFUEL) of the pressure of the fuel (the fuel pressure) supplied to the first fuel injection valve 11 during the fuel cut is calculated. This target fuel pressure (TPFUEL) during the fuel cut is calculated by the piston temperature (ESPSTMP) calculated at S22, and, for example, the target fuel pressure calculation map shown in FIG. 8. The target fuel pressure (TPFUEL) during the fuel cut becomes higher as the piston temperature (ESPSTMP) becomes lower. At S25, the permissible maximum fuel pressure (PFADMX) and the target fuel pressure (TPFUEL) during the fuel cut are compared with each other. When the permissible maximum fuel pressure (PFADMX) is greater than the target fuel pressure (TPFUEL) during the fuel cut, the process proceeds to S26. Otherwise, the process proceeds to S27. At S26, the recovery target fuel pressure (TPFUELR) which is the pressure of the fuel (the fuel pressure) supplied to the first fuel injection valve 11 at the fuel cut recovery is set to the target fuel pressure (TPFUEL) during the fuel cut which is calculated at S24. At S27, the recovery target fuel pressure (TPFUELR) which is the pressure of the fuel (the fuel pressure) supplied to the first fuel injection valve 11 at the fuel cut recovery is set to the permissible maximum fuel pressure (PFADMX) calculated at S23.

At S28, it is judged whether or not the fuel cut is finished. That is, it is judged whether or not the fuel cut recovery conditions are satisfied. When the fuel cut recovery conditions are satisfied, the process proceeds to S29. When the fuel cut recovery conditions are not satisfied, the process proceeds to S22. At S29, the piston temperature (ESPSTMP) is calculated. The piston temperature (ESPSTMP) calculated at S29 is calculated from a predetermined calculation formula by using the piston temperature at the end of the fuel cut control, the accumulated intake air amount after the end of the fuel cut control, and so on. At S30, the target fuel pressure (TPFUELRS) of the pressure of the fuel (the fuel pressure) supplied to the first fuel injection valve during the rich spike is calculated. This target fuel pressure (TPFUELRS) during the rich spike is the target fuel pressure (TPFUEL) calculated by the piston temperature (ESPSTMP) calculated at S29, and, for example, the target fuel pressure (TPFUEL) calculated by the target fuel pressure calculation map as shown in FIG. 8. The target fuel pressure (TPFUELRS) becomes higher as the piston temperature (ESPSTMP) becomes lower. At S31, it is judged whether or not the rich spike is finished. When the rich spike is finished, the process proceeds to S32. When the rich spike is not finished, the process proceeds to S29. At S32, the target fuel pressure (TPFUEL) is set to the normal state fuel pressure (TPFUELN) calculated from the above-described normal state fuel pressure calculation map of FIG. 2 by using the current engine load and the current engine speed.

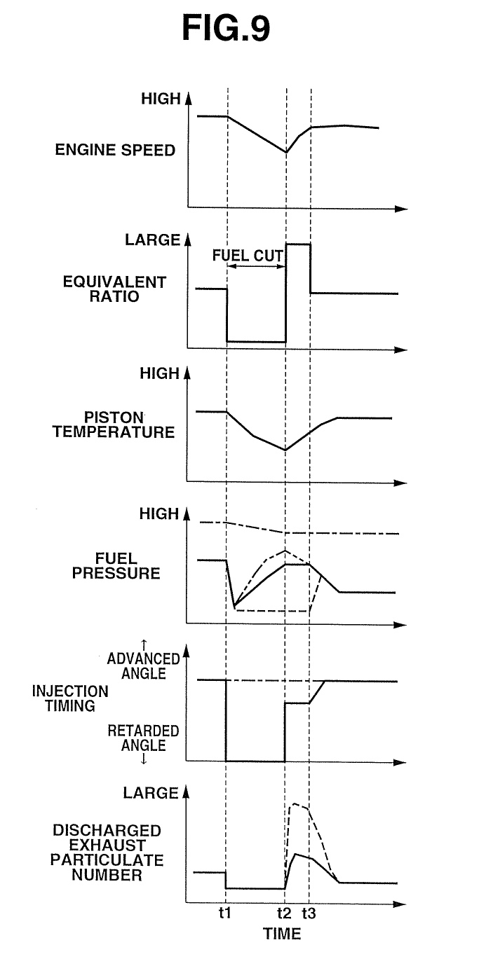

A third embodiment of the present invention is explained with reference to FIG. 9 to FIG. 11. The third embodiment has a configuration which is similar to that of the first embodiment. In the third embodiment, the pressure of the fuel (the fuel pressure) supplied to the first fuel injection valve 11 at the end of the fuel cut control is controlled to be increased to be greater than the normal state fuel pressure shown by a broken line in FIG. 9.

In this third embodiment, in a case where the pressure of the fuel (the fuel pressure) supplied to the first fuel injection valve 11 is smaller than the target fuel pressure shown by a two dot line in FIG. 9 by a predetermined value when the fuel cut recovery conditions are satisfied, the timing of the fuel injection during the intake process of the first fuel injection valve 11 is set to be retarded from the fuel injection timing in the normal state. Besides, the fuel pressure shown by one dot line in FIG. 9 is the above-described permissible maximum fuel pressure determined from the minimum fuel injection pulse width of the first fuel injection 11.

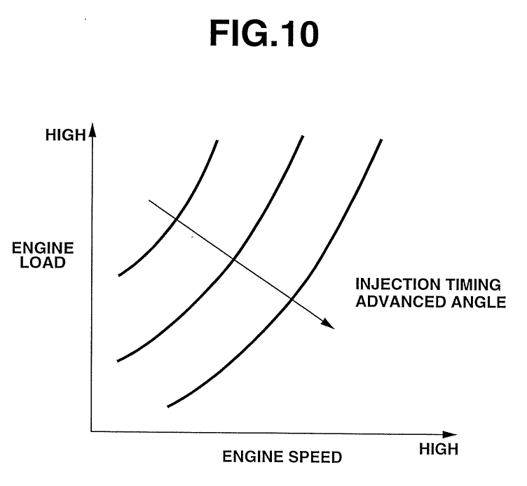

The normal state fuel injection timing 11 which is the fuel injection timing in the normal state is calculated, for example, by using a normal state injection timing calculation map shown in FIG. 10. In the normal state injection timing calculation map, the calculated normal state injection timing is set to be retarded as the engine load becomes lower, and as the engine speed becomes higher.

Moreover, the recovery fuel injection timing of the first fuel injection valve 11 set in a case where the pressure of the fuel (the fuel pressure) supplied to the first fuel injection valve 11 is smaller than the target fuel pressure by the predetermined value or more at the satisfaction of the fuel cut recover conditions is, for example, a timing near a lower dead center of the intake process, and is set to be retarded relative to the normal state injection timing.

In FIG. 9, the fuel cut conditions are satisfied at time t1. At time t2, the fuel cut recovery conditions are satisfied by the depression of the accelerator pedal. Moreover, the equivalent ratio during the predetermined period from the time t2 is controlled to be temporarily increased. That is, the rich spike by which the fuel injection amount injected from the first fuel injection valve 11 is temporarily increased is performed.

In FIG. 9, at time t2 at which the fuel cut recovery conditions are satisfied, the pressure of the fuel (the fuel pressure) supplied to the first fuel injection valve 11 is higher than the normal state fuel pressure shown by the broken line, and smaller than the target fuel pressure. Accordingly, in the third embodiment, the timing of the fuel injection of the first fuel injection valve 11 during the rich spike is set to the recovery injection timing which is the timing on the retarded angle side of the normal state injection timing.

Besides, in this third embodiment, the pressure of the fuel (the fuel pressure) supplied to the first fuel injection valve 11 is set to be increased in accordance with the temperature of the piston 9, like the above-described second embodiment.

Therefore, in this third embodiment, when the fuel injection is restarted from the first fuel injection valve 11 after the fuel cut control is finished, it is possible to largely decrease the discharge number of the exhaust particulate, relative to a case where the fuel pressure is set to the normal state fuel pressure as shown by a broken line in FIG. 9. Accordingly, it is possible to suppress the discharge amount of the exhaust particulate. Moreover, in this third embodiment, it is possible to attain the operations and the effects that may be similar to those of the above-described first and second embodiments.

Moreover, in this third embodiment, even when the pressure of the fuel (the fuel pressure) supplied to the first fuel injection valve 11 is not sufficiently increased at the satisfaction of the fuel cut recovery conditions, it is possible to decrease the adhesion amount of the fuel spray injected from the first fuel injection valve to the piston 9, by retarding the fuel injection timing of the first fuel injection valve 11. With this, it is possible to suppress the increases of the discharge amount of the exhaust particulate, and the discharge number of the exhaust particulate.

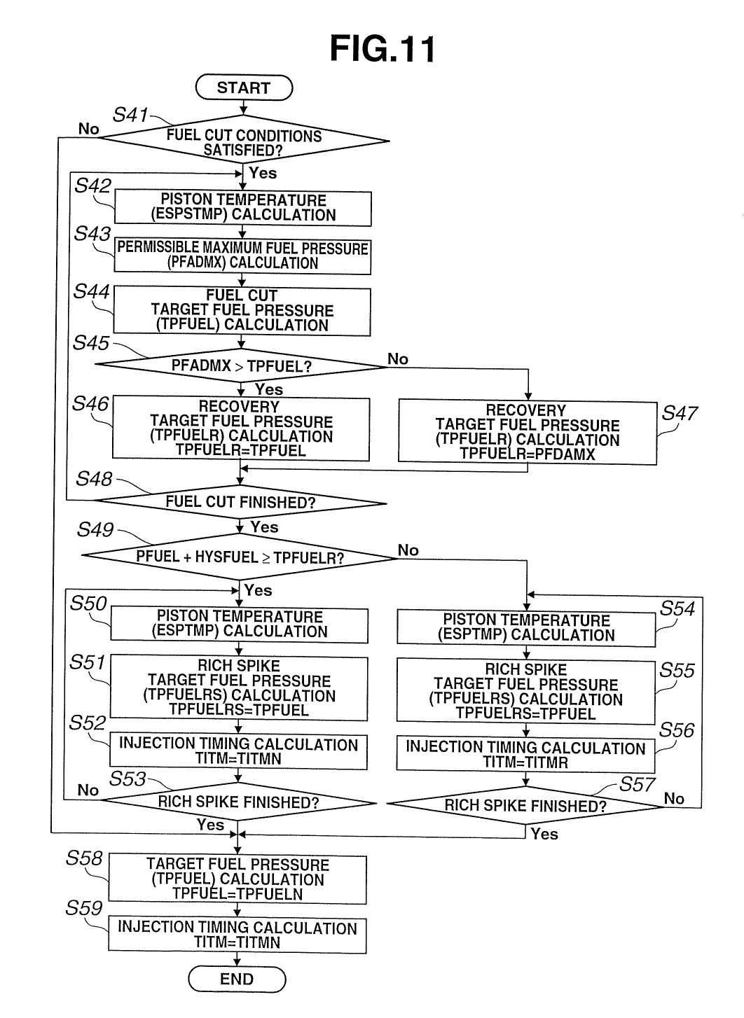

FIG. 11 is a flow chart showing a flow of the control in the above-described third embodiment. At S41, it is judged whether or not the fuel cut conditions are satisfied. When the fuel cut conditions are satisfied, the process proceeds to S58. When the fuel cut conditions are not satisfied, the process proceeds to S42. At S42, the piston temperature (ESPSTMP) is calculated from the predetermined calculation formula by using the engine load immediately before the fuel cut control, and the accumulated intake air amount during the fuel cut control, and so on. At S43, the permissible maximum fuel pressure (PFADMX) is calculated. At S44, the target fuel pressure (TPFUEL) of the pressure of the fuel (the fuel pressure) supplied to the first fuel injection valve 11 during the fuel cut is calculated. This target fuel pressure (TPFUEL) during the fuel cut is calculated by using the piston temperature calculated at S42, for example, and the above-described target fuel pressure calculation map shown in FIG. 8. The target fuel pressure (TPFUEL) during the fuel cut becomes higher as the piston temperature (ESPSTMP) becomes lower. At S45, the permissible maximum fuel pressure (PFADMX) and the target fuel pressure (TPFUEL) during the fuel cut are compared with each other. When the permissible maximum fuel pressure (PFADMX) is greater than the target fuel pressure (TPFUEL) during the fuel cut, the process proceeds to S46. Otherwise, the process proceeds to S47. At S46, the recovery target fuel pressure (TPFUELR) which is the pressure (the fuel pressure) supplied to the first fuel injection valve 11 at the fuel cut recovery is set to the target fuel pressure (TPFUEL) during the fuel cut. At S47, the recovery target fuel pressure (TPFUELR) which is the pressure (the fuel pressure) supplied to the first fuel injection valve 11 at the fuel cut recovery is set to the permissible maximum fuel pressure (PFADMX).

At S48, it is judged whether or not the fuel cut is finished. That is, it is judged whether or not the fuel cut recovery conditions are satisfied. When the fuel cut recovery conditions are satisfied, the process proceeds to S49. When the fuel cut recovery conditions are not satisfied, the process proceeds to S42. At S49, it is judged whether or not the summation of the actual fuel pressure (PFUEL) sensed by the fuel pressure sensor 27 and the predetermined value (HYSFUEL) previously set is equal to or greater than the recovery target fuel pressure (TPFUELLR) calculated immediately before the end of the fuel cut control. That is, when the fuel cut recovery conditions are satisfied, it is judged whether or not the pressure of the fuel (the fuel pressure) supplied to the first fuel injection valve 11 reaches the target fuel pressure. When it reaches the target fuel pressure, the process proceeds to S50. When it does not reach the target fuel pressure, the process proceeds to S54.

At S50, the piston temperature (ESPSTMP) is calculated. The piston temperature (ESPSTMP) calculated at S50 is calculated from the predetermined calculation formula by using the piston temperature at the end of the fuel cut control and the accumulated intake air amount after the end of the fuel cut control, and so on. At S51, the target fuel pressure (TPFUELRS) of the pressure of the fuel (the fuel pressure) supplied to the first fuel injection valve 11 during the rich spike is calculated. This target fuel pressure (TPFUELRS) during the rich spike is the target fuel pressure (TPFUEL) calculated by using the piston temperature (ESPSTMP) calculated at S50, and for example, the above-described target fuel pressure calculation map shown in FIG. 8. The target fuel pressure during the rich spike becomes higher as the piston temperature (ESPSTMP) becomes lower. At S52, the fuel injection timing (TITM) of the first fuel injection valve 11 is set to the normal state injection timing (TITMN) calculated, for example, by using the normal state injection timing calculation map shown in FIG. 10. At S53, it is judged whether or not the rich spike is finished. When the rich spike is finished, the process proceeds to S58. When the rich spike is not finished, the process proceeds to S50.

At S54, the piston temperature (ESPSTMP) is calculated. The piston temperature (ESPSTMP) calculated at S54 is calculated from the predetermined calculation formula by using the piston temperature at the end of the fuel cut control, and the accumulated intake air amount after the end of the fuel cut control, and so on. At S55, the target fuel pressure (TPFUELRS) of the pressure of the fuel (the fuel pressure) supplied to the first fuel injection valve 11 during the rich spike is calculated. This target fuel pressure (TPFUELRS) during the rich spike is the target fuel pressure (TPFUEL) calculated by the piston temperature (ESPSTMP) calculated at S54, and, for example, the above-described target fuel pressure calculation map shown in FIG. 8. This target fuel pressure (TPFUELRS) becomes higher as the piston temperature becomes lower. At S56, the fuel injection timing (TITM) of the first fuel injection valve 11 is set to the recovery injection timing (TITMR) which is the timing on retarded angle side of the normal state injection timing. For example, this recovery injection timing (TITMR) may be set to be retarded as the piston temperature is lowered. At S57, it is judged whether or not the rich spike is finished. When the rich spike is finished, the process proceeds to S58. When the rich spike is not finished, the process proceeds to S54.

At S58, the target fuel pressure (TPFUEL) is set to the normal state fuel pressure calculated from the above-described normal state fuel pressure calculation map by using the current engine load and the current engine speed. At S59, the fuel injection timing (TITM) of the first fuel injection valve 11 is set to the normal state injection timing (TITMN) calculated, for example, by using the normal state injection timing calculation map shown in FIG. 10. Besides, in a case where the previous injection timing is retarded than the injection timing calculated at S59, that is, for example, immediately after the rich spike, the injection timing at this time is set to the injection timing which is obtained by advancing the current injection timing by the predetermined amount. The injection timing is gradually advanced toward the normal injection timing.

The present invention is not limited to the above embodiments. For example, when the fuel injection is restarted from the first fuel injection valve, the pressure of the fuel (the fuel pressure) supplied to the first fuel injection valve 11 may be determined in consideration of the length of the fuel cut control, and the temperature of the piston 9.

Moreover, in one or more of the above-described embodiments, the exhaust air purification capability of the three-way catalyst 13 is recovered by the rich spike by which the fuel injection amount injected from the first fuel injection valve 11 is temporarily increased. However, the exhaust air purification capability of the three-way catalyst 13 may be recovered, for example, by injecting the fuel into the exhaust passage 16 on the upstream side of the three-way catalyst 13 after the end of the fuel cut control.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A control device for an internal combustion engine of a vehicle, comprising:
a controller that controls a fuel injection valve of the internal combustion engine arranged to directly inject a fuel into a combustion chamber, and a pressure regulator of the internal combustion engine arranged to vary a pressure of the fuel supplied to the fuel injection valve,
wherein the controller performs a fuel cut that stops the fuel injection of the fuel injection valve when a predetermined fuel cut condition is satisfied during a traveling of the vehicle,
wherein the controller restarts the fuel injection of the fuel injection valve when a predetermined fuel cut recovery condition is satisfied during the fuel cut,
wherein the pressure of the fuel supplied to the fuel injection valve is set to a value higher than a normal state fuel pressure determined in accordance with a driving state, at the restart of the fuel injection after the fuel cut, and
wherein the pressure of the fuel supplied to the fuel injection valve is increased at the restart of the fuel injection from the fuel cut as a time period of the fuel cut becomes longer.

2. (canceled)

3. The control device for the internal combustion engine as claimed in claim 1, wherein the pressure of the fuel supplied to the fuel injection valve is increased at the restart of the fuel injection from the fuel cut as the piston temperature becomes lower.

4. The control device for the internal combustion engine as claimed in claim 1, wherein the pressure of the fuel supplied to the fuel injection valve is previously increased during the fuel cut.

5. The control device for the internal combustion engine as claimed in claim 1, wherein a maximum value of the pressure of the fuel supplied to the fuel injection valve during the fuel cut is determined by an intake air amount during the fuel cut, and a minimum fuel injection pulse width of the fuel injection valve.

6. The control device for the internal combustion engine as claimed in claim 1, wherein a maximum value of the pressure of the fuel supplied to the fuel injection valve during the fuel cut is determined by an intake air amount at an idling drive, and a minimum fuel injection pulse width of the fuel injection valve.

7. The control device for the internal combustion engine as claimed in claim 1, wherein a fuel injection timing is retarded when the pressure of the fuel supplied to the fuel injection valve is lower than a target fuel pressure by a predetermined vale or more at the start of the fuel cut.

8. The control device for the internal combustion engine as claimed in claim 1, wherein a rich spike by which the fuel injection amount of the fuel injection valve is temporarily increased is performed at the restart of the fuel injection from the fuel cut.
